(19) United States
(12) Patent Application Publication
(10) Pub. No.: US 2025/0050603 A1
(43) Pub. Date: Feb. 13, 2025

(54) MANUFACTURING METHOD OF A LENS ASSEMBLY, MANUFACTURING DEVICE OF A LENS ASSEMBLY, AND LENS ASSEMBLY

(71) Applicants: Asphetek Solution (Chengdu) Ltd., Chengdu (CN); Asphetek Solution Inc., Hsinchu (TW)

(72) Inventor: HSIANG TSAI, Hsinchu (TW)

(21) Appl. No.: 18/637,222

(22) Filed: Apr. 16, 2024

(30) Foreign Application Priority Data
Aug. 7, 2023 (CN) 202310993612.4

(51) Int. Cl. B29D 11/00

(52) U.S. Cl. CPC B29D 11/00951; B29D 11/00432; B29D 11/0049; B29D 11/00923

(57) ABSTRACT

A manufacturing method of a lens assembly includes heating the first lens and softening the first lens; and pressing the softened first lens to the second lens, bonding the first face with the second face, and hot melt connecting the first connection portion with the second connection portion. The beneficial effect of the present application is to improve the accuracy of the first laminating surface being affixed to the second laminating surface, and to improve the imaging effect of the lens assembly.

### FIELD

The present disclosure relates to field of optical component technology, particularly to a manufacturing method of a lens assembly, a manufacturing device of a lens assembly and a lens assembly.

### BACKGROUND

During jointing of existing lens assembly, two lenses joint to each other with aqueous hot melt adhesive, a gap can be easily formed between optical surfaces of the two lenses, and dimensions of the gaps at various places on the surface of the lens are different, resulting the optical surfaces of the two lenses become non-parallel or eccentric, distorted an optical path through the lens assembly, reduced Modulation Transfer Function of the lens assembly, and imaging distortions by the lens assembly.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding portions throughout the several views.

FIG. 1 is a manufacturing method of a lens assembly according to an embodiment of the present disclosure.

FIG. 2 is another manufacturing method of a lens assembly according to an embodiment of the present disclosure.

FIG. 3 is a diagrammatic view of a manufacturing device of lens assemblies according to an embodiment of the present disclosure.

FIG. 4 is a diagrammatic view of a localized structure of the manufacturing device shown in FIG. 3.

FIG. 5 is a diagrammatic view of a lens assembly according to an embodiment of the present disclosure.

### DESCRIPTION OF MAIN COMPONENTS OR ELEMENTS

lens assembly 100;
first lens 10;
first optical portion 11;
first connecting portion 12;
first face 13;
second lens 20;
second optical portion 21;
second connecting portion 22;
second face 23;
plating layer 24;
manufacturing device of a lens assembly 200;
locating mold 30;
locating groove 31;
pressing mold 40;
pressing groove 41;
heating assembly 50;
radiant heating face 51;
insulating portion 60;
insulating cap 61;
insulating board 62;
heating element 71;
heating tube 71a;
temperature detector 72;
first heating area Q1;
second heating area Q2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

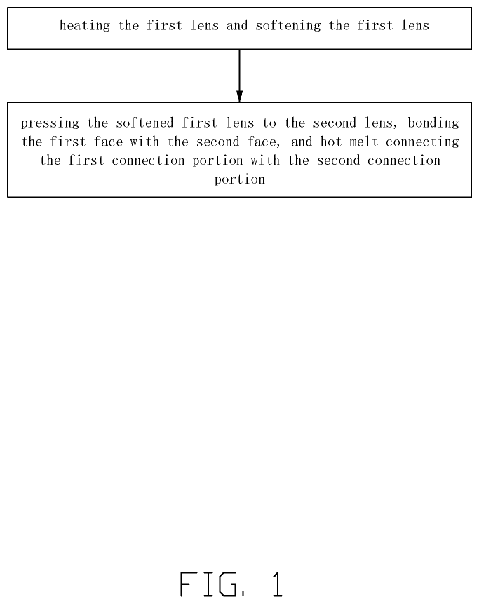

Referring to FIG. 1, a manufacturing method of a lens assembly is provided, the lens assembly comprises a first lens 10 and a second lens 20. The manufacturing method of the lens assembly for jointing the first lens 10 to the second lens 20. The first lens 10 includes a first optical portion 11 and a first connecting portion 12, the first connecting portion 12 is positioned at an edge of the first optical portion 11. The first optical portion 11 comprises a first face 13. The second lens 20 includes a second optical portion 21 and a second connecting portion 22, the second connecting portion 22 is positioned at an edge of the first second portion 21. The second optical portion 21 comprises a second face 23.

The manufacturing method of lens includes: heating the first lens 10 and softening the first lens 10; pressing the softened first lens 10 to the second lens 20, bonding the first face 13 with the second face 23, and hot melt connecting the first connection portion 12 with the second connection portion 22.

At room temperature, the first lens 10 and the second lens 20 are hard materials, the first optical portion 11 has a melting point. Heating the first optical portion 11 to a temperature below melting point of the first optical portion 11, so the first optical portion 11 can be softened, the softened first optical portion 11 is malleable, and the softened first optical portion 11 can deform under an action of forces.

The second face 23 remains fixed, after press the softened first lens 10 over the second face 23, the first face 13 of the softened first optical portion 11 can deform under the action of the second face 23, and the first face 13 fits to the second face 23 tightly and accurately, and reduces the likelihood of a gap between the first face 13 and the second face 23 significantly, and improve overlap accuracy between the first face 13 and the second face 23 significantly, and path of light passing through the first lens 10 and the second lens 20 satisfies requirement, and light is not shifted due to foreign objects or non-parallelism, and improve imaging quality of the lens assembly 100.

Furthermore, heating the first connecting portion 12 to a temperature below melting point of the first connecting portion 12, and melt the second connecting portion 12. After the melted first connecting portion 12 attach the second connecting portion 22, heat generated by the first connecting portion 12 is transferred from the first connecting portion 12 to the second connecting portion 22, temperature of the second connecting portion 22 is raised, causing microscopic changes at contact face between the first connecting portion 12 and the second connecting portion 22, jointing the first connecting portion 12 with the second connecting portion 22, improving stability of the connection between the first connecting portion 12 and the second connecting portion 22, and improving image quality of the lens assembly 100.

In addition, process of heating the first lens 10 and pressing the first lens 10 with the second lens 20 is simple and easy to perform, and has low stability requirements for the materials of the lens assembly 100, so the manufacturing method of a lens assembly has advantages of low cost and high processing efficiency.

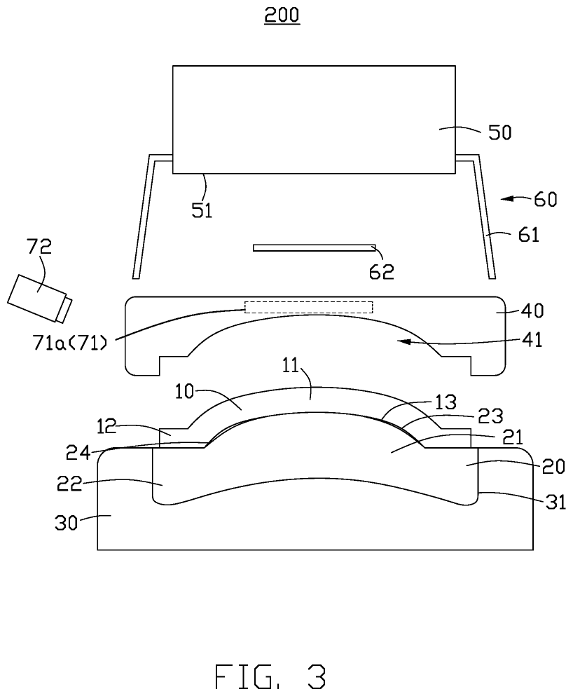

In one embodiment, referring to FIG. 3, the first boding face 13 is a concave surface in a surface of the first optical portion 11, the second face 23 is a convex surface of in a surface of the second optical portion 21. In other embodiment, the first boding face 13 could be a first plane or a first aspherical composite surface, the first aspherical composite surface is designed by the optical transmission requirement. In other embodiment, the second face 23 could be a second plane or a second aspherical composite surface, the second aspherical composite surface is designed by the optical transmission requirement.

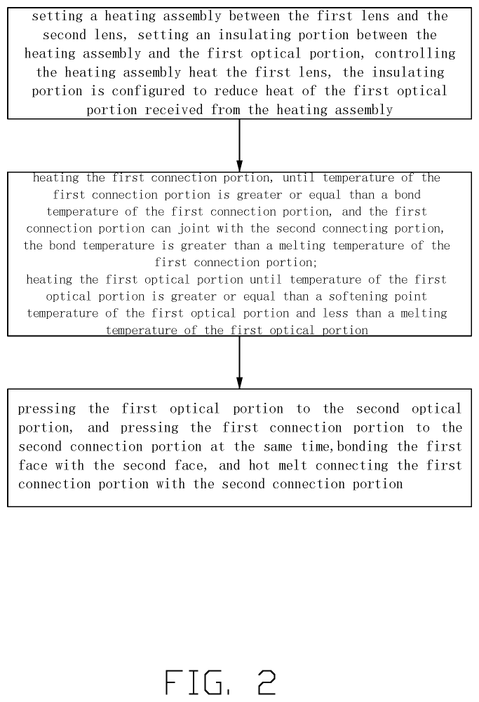

In one embodiment, referring to FIG. 2, process of heating the first lens 10 and softening the first lens 10 includes: heating the first lens 10, until a temperature of the first connection portion 12 is greater than or equal to a bond temperature of the first connection portion 12, and the first connection portion 12 can joint with the second connecting portion 22. The bond temperature is greater than a melting temperature of the first connection portion 12, to ensure that the first connection portion 12 can be partially melted to connect with the second connection portion 22. The process of heating the first lens 10 and softening the first lens 10 further includes: heating the first optical portion 11 until the temperature of the first optical portion 11 is greater than or equal to a softening point temperature of the first optical portion 11 and less than a melting temperature of the first optical portion, and make sure the first optical portion 11 doesn't melt.

In one embodiment, the bond temperature of the first connection portion 12 can be adjusted according to material of the first connection portion 12. The softening point temperature of the first optical portion 11 can be adjusted according to material of the first optical portion 11. In one embodiment, material of the first lens 10 is plastic, and the bond temperature can be set between 60° C. to 300° C., the softening point temperature can be set between 60° C. to 300° C.

In one embodiment, the plastic can be (Polymethyl Methacrylate) PMMA, (Polycarbonate) PC, (Dially Glycol Carbonates) CR-39, these materials have good thermoplastic and optical property. In one embodiment, the material of the first lens 10 is PMMA, melting temperature of PMMA is about 160° C., heat distortion temperature of PMMA is about 120° C., the softening point temperature of the first optical portion 11 can be set between 130° C. to 150° C., for example, the softening point temperature of the first optical portion 11 can be set as 130° C., 135° C., 140° C., 45° C. or 150° C., the bond temperature of the first connecting portion 12 is greater than 160° C. for example, the softening point temperature of the first connecting portion 12 can be set as 160° C., 165° C. or 170° C.

In one embodiment, referring to FIG. 2, process of pressing the softened the first lens 10 to the second lens 20 includes: pressing the first optical portion 11 to the second optical portion 21, and pressing the first connection portion 12 to the second connection portion 22 at the same time.

It can be simultaneously achieved that the first surface 13 is accurately fitted to the second surface 23, and that the first connecting portion 12 is securely attached to the second connecting portion 22, and improve connection efficiency between the first lens 10 to the second lens 20.

In other embodiment, process of pressing the first optical portion 11 to the second optical portion 21 and process of pressing the first connection portion 12 to the second connection portion 22 in sequence.

In one embodiment, referring to FIG. 2, process of heating the first lens 10 includes: setting a heating assembly 50 between the first lens 10 and the second lens 20, controlling the heating assembly 50 heat the first lens 10, setting an insulating portion 60 between the heating assembly 50 and the first optical portion 11, the insulating portion 60 is configured to reduce heat of the first optical portion 11 receives from the heating assembly 50.

The insulating portion 60 is configured to reduce the amount of heat the first optical portion 11 receives from the heating assembly 50, and heating speed of the first optical portion 11 is lower than the first connecting portion 12. Therefore, when temperature of the first connecting portion 12 is higher than the bonding temperature, temperature of the first optical portion 11 is between the softening point temperature and the melting point. So the first optical portion 11 and the first connecting portion 12 can be heated at the same time, and reduce heating time for the first lens 10, and improve connection efficiency between the first lens 10 to the second lens 20.

In one embodiment, material of the first optical portion 11 is the same as material of the first connecting portion 12, thereby improving manufacturing efficiency for the first lens 10.

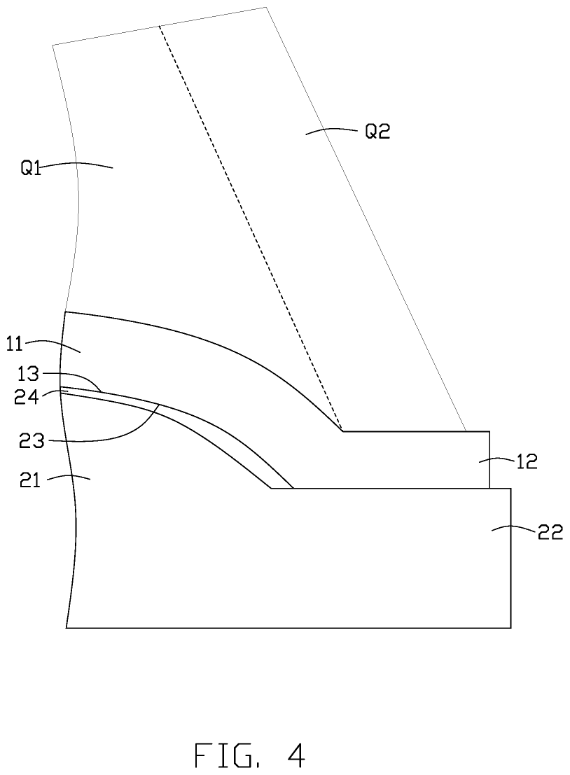

Referring to FIG. 3 and FIG. 4, a manufacturing device 200 of lens assembly 100 is provided. The manufacturing device 200 of lens assembly 100 includes a locating mold 30, pressing mold 40 and heating assembly 50. The locating mold 30 defines a locating groove 31, the locating groove 31 is configured to receive the second lens 20, the pressing groove 41 is configured to receive the first lens 10. The locating mold 30 defines a first open end, the pressing mold defines a second open end, the first open end is connected to the second open end. The heating assembly 50 is capable moves to the locating groove 31 side of the locating mold 30. The heating assembly 50 is configured to heat the first lens 10 to soften the first optical portion 11, and melt the first connecting portion 12. The pressing mold 40 is used to press on the locating mold 30, and presses the softened first optical portion 11 on the second optical portion 21, and connects the first connecting portion 12 with the second connecting portion 22.

The locating groove 31 is configured to clamp the second lens 20, and the position and shape of the second lens 20 remain fixed during the attachment of the first lens 10 to the second lens 20, and reduce displacement between the first lens 10 and the second lens 20 during the pressing process, and improve overlap accuracy between the first lens 10 and the second lens 20.

In one embodiment, the material of the pressing mold 40 is graphite, in other embodiment, the material of the pressing mold 40 can be metal.

After the heating assembly 50 heats and softens the first lens 10 on the second lens 20, the pressing mold 40 can press the first lens 10 on the second lens 20 under an action of an external force, and bonds the first face 13 with the second face 23, connects the first connecting portion 12 and the second connecting portion 22, and joint the first lens 10 with the second lens 20 to the lens assembly 100.

A closed space is formed between the pressing groove 41 and the locating groove 31 enclose. The closed space can limit shape of the first lens 10 and the second lens 20, and shapes of the first lens 10 and the second lens 20 remain unchanged during pressing process.

In one embodiment, the shape of the locating groove 31 is imitating with the second lens 20, the second lens 20 can be matched the locating groove 31, and improve stability of the locating groove 31 clamping the second lens 20.

In one embodiments, shape of the pressing groove 41 is imitating with standard surface of the first lens 10, the softened first lens 10 press the pressing groove 41 under pressure, and shape of surface of the softened first lens 10 is same to the shape of the pressing groove 41, and the shape of the softened first lens 10 is same with the standard surface of the first lens 10, and path of light passing through the first lens 10 satisfies requirement.

The manufacturing device 200 of lens assembly 100 improves the binding quality and binding efficiency of the first lens 10 and the second lens 20, and improves image quality of the lens assembly 100.

In one embodiment, the heating assembly 50 is set as a non-contact heating component. For example, the heating assembly 50 can be set as infrared heating lamp assembly or heating ceramic plates. In other embodiment, the heating assembly 50 can be set as contact heating component, and the contact heating component attach the pressing mold 40 to heating the pressing mold 40.

In one embodiment, referring to FIG. 3, the manufacturing device 200 of lens assembly 100 includes a heating element 71, the heating element 71 is configured to heat the pressing mold 40, to keep difference value between the temperature of the pressing mold 40 and the temperature of the softened first optical portion 11 within a preset range, and reduce the temperature difference between the pressing mold 40 and the softened first optical portion 11. Therefore, contacting surfaces of the first lens 10 and the pressing mold 40 remain contact, and do not deteriorate during the pressing mold 40 pressing the first lens 10.

Temperature at which the heating element 71 heats the pressing mold 40 is less than the softening point temperature of the first lens 10. For example, when the softening point temperature of the first optical portion 11 is between 130° C. to 150° C., the temperature at which the heating element 71 heats the pressing mold 40 is between 120° C. to 130° C.

In one embodiment, the heating element 71 include heating tube 71a, the heating tube 71a is embedded in the pressing mold 40. The heating tube 71a can be ceramic heating tube or resistive heating tube.

In one embodiment, material of the pressing mold 40 is metal with good thermal conductivity. In other embodiment, the material of the pressing mold 40 can be other materials with good thermal conductivity.

In one embodiment, referring to FIG. 3 and FIG. 4, the manufacturing device 200 of lens assembly 100 includes a insulating portion 60, the insulating portion 60 is placed between the first optical portion 11 and the heating assembly 50, the insulating portion 60 is configured to reduce the amount of heat the first optical portion 11 receives from the heating assembly 50, so temperature of the first optical portion 11 is lower than temperature of the first connecting portion 12. Under the effect of the heating assembly 50, the heating assembly 50 can heat the first optical portion 11 and the first connecting portion 12 at the same time, and improve heating efficiency of the first lens 10, and improve jointing efficiency of the lens assembly 100.

In one embodiment, the insulating portion 60 is connected with the heating assembly 50.

In one embodiment, referring to FIG. 4, a projection of the insulating portion 60 onto the first optical portion 11 lies inside the outer face of the first optical portion 11, and insulate inner area of the first optical portion 11 and outer area of the first optical portion 11, and ensure the temperature control effect of the first optical portion 11.

In one embodiment, referring to FIG. 4, the insulating portion 60 includes an insulating cap 61 and an insulating board 62.

The insulating cap 61 surrounds outer side of the first optical portion 11, and the insulating cap 61 is between the first optical portion 11 and the first connecting portion 12, and an inner side of the first optical portion 11 defines a first heating area Q1, an outer side of the first optical portion 11 defines a second heating area Q2. The insulating cap 61 can reduce amount of heat radiated by the heating assembly 50 from the second heating area Q2 to the first heating area Q1.

The insulating board 62 is placed between the heating assembly 50 and the first optical portion 11, and reduce amount of heat radiated by the heating assembly 50 from the heating assembly 50 to the first optical portion 11.

In one embodiment, the heating assembly 50 defines a radiant heating face 51, the radiant heating face 51 is parallel to the insulating board 62.

In one embodiment, a cross section of the insulating board 62 is same with a cross section of the first optical portion 11, and the cross section of the insulating board 62 is bigger than the cross section of the first optical portion 11, thereby improving insulation of the insulating board 62.

In one embodiment, referring to FIG. 3, the manufacturing device 200 of lens assembly 100 includes a temperature detector 72, the temperature detector 72 is configured to detect temperature of the first optical portion 11 and temperature of the first connecting portion 12, and the heating assembly can stop heating when temperature of the first optical portion 11 reaches the softening point temperature and temperature of the first connecting portion 12 reaches the melting temperature.

In one embodiment, the temperature detector 72 can be set as a thermal imager, the thermal imager and the first lens 10 are spaced apart.

Workflow of the manufacturing device 200 of lens assembly is as follows:

Placing the second lens 20 in the locating groove 31 of the locating mold 30, and placing the insulating portion 60 on the side of the second lens 20 away from the locating mold 30.

Heating assembly 50 heating the first lens 10 until the first optical portion 11 become softened and the first connecting portion 12 become melted, and placing the heated first lens 10 on the second face 23. Or, placing the first lens 10 on the second face 23, and heating assembly 50 heating the first lens 10 until the first optical portion 11 become softened and the first connecting portion 12 become melted.

Moving the heating assemble 50 and the insulating portion 60.

Heating tube 71a heating the pressing mold 40, and placing the heated pressing mold 40 on the first lens 10, and the first lens 10 is nested inside the pressing groove 41. Pressing the pressing mold 40 on the locating mold 30, to press the first lens 10 on the second lens 20, and bond the first face 13 with the second boding face 23, connecting the first connecting portion 12 with the second connecting portion 22.

Leaving to cool the pressing mold 40 and the locating mold 30 until temperature of the pressing mold 40 and the locating mold 30 reduced to a room temperature, separating the pressing mold 40 and the locating mold 30, and removing the first lens 10 jointed with the second lens 20.

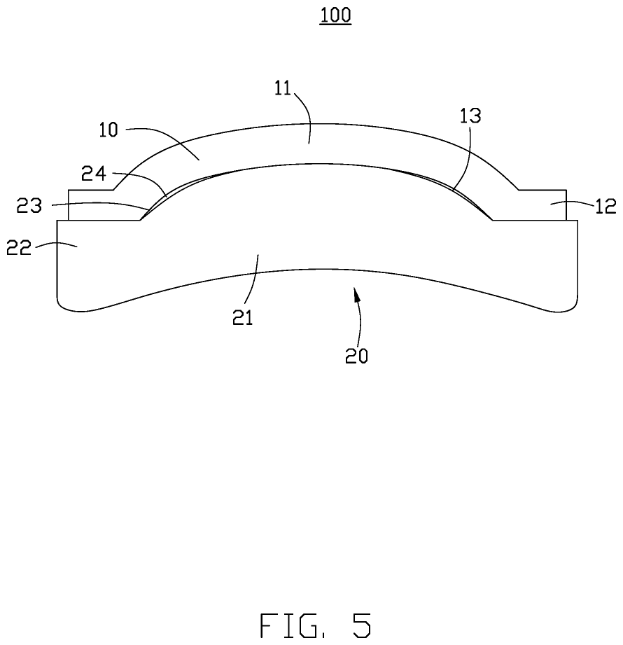

In one embodiment, referring to FIG. 5, a lens assembly 100 is provided. The lens assembly 100 includes a first lens 10 and a second lens 20. The first lens 10 includes a first optical portion 11 and a first connecting portion 12, the first connecting portion 12 is connected to edge of the first optical portion 11. The first optical portion 11 has a first face 13. The second lens 20 includes a second optical portion 21 and a second connecting portion 22, the second connecting portion 22 is connected to edge of the first second portion 21. The second optical portion 21 has a second face 23. The first face 13 bond the second face 23, the first connection portion 12 is hot melt connect with the second connection portion 22.

The lens assembly 100 of this embodiment is processed by the manufacturing method of a lens assembly, and the first face 13 can fit onto the second face 23 accurately and reliably, and improve the imaging quality of the lens assembly 100, and path of light passing through the lens assembly 100 satisfies requirement.

In one embodiment, referring to FIG. 5, the second lens 20 includes a plating layer 24, the plating layer 24 is coated on the second optical portion 21, and surface of the plating layer 24 is formed as the second face 23, and the plating 24 layer is transflective, the plating layer 24 can make the lens assembly 100 translucent and reflective. Processing the lens assembly 100 through the manufacturing method of a lens assembly, the first face 13 is affixed to the second face 23 at all points, there will be no gap between the first face 13 and the second face 23, and improve the parallelism of the first face 13 and the second face 23, and improve the processing quality of the lens assembly 100.

What is claimed is:

1. A manufacturing method of a lens assembly, the lens assembly comprising a first lens and a second lens, the manufacturing method of the lens assembly is configured for jointing the first lens with the second lens, the first lens comprises a first optical portion and a first connecting portion, the first connecting portion is positioned at an edge of the first optical portion, the first optical portion comprises a first face; the second lens comprises a second optical portion and a second connecting portion, the second connecting portion is positioned at an edge of the second optical portion. The second optical portion comprises a second face; the manufacturing method of the lens assembly comprising:
heating the first lens and softening the first lens; and
pressing the softened first lens to the second lens, bonding the first face with the second face, and hot melt connecting the first connection portion with the second connection portion.

2. The manufacturing method of a lens assembly as claimed in claim 1, the heating the first lens and softening the first lens comprises:
heating the first connection portion, until temperature of the first connection portion is greater or equal than a bond temperature of the first connection portion, and the first connection portion can joint with the second connecting portion, the bond temperature is greater than a melting temperature of the first connection portion;
heating the first optical portion until temperature of the first optical portion is greater or equal than a softening point temperature of the first optical portion and less than a melting temperature of the first optical portion.

3. The manufacturing method of a lens assembly as claimed in claim 2, the heating the first lens comprises:
setting a heating assembly between the first lens and the second lens, setting an insulating portion between the heating assembly and the first optical portion, controlling the heating assembly heat the first lens, the insulating portion is configured to reduce heat of the first optical portion received from the heating assembly.

4. The manufacturing method of a lens assembly as claimed in claim 1, the pressing the softened first lens to the second lens comprises:
pressing the first optical portion to the second optical portion, and pressing the first connection portion to the second connection portion at the same time.

5. A manufacturing device of a lens assembly, the manufacturing device of the lens assembly is configured to implement the manufacturing method of the lens assembly as claimed in claim 1, comprising:
a locating mold, the locating mold defines a locating groove, the locating groove is configured to receive the second lens, and the locating mold defines a first open end; and
a heating assembly, the heating assembly is capable moves to the locating groove side of the locating mold, the heating assembly is configured to heat the first lens to soften the first optical portion, and melt the first connecting portion; and
a pressing mold, the pressing mold is configured to receive the first lens, the pressing mold defines a second open end, the second open end connects to the first open end, the pressing mold is configured to press on the locating mold, and presses the softened first optical portion on the second optical portion, and connects the first connecting portion with the second connecting portion.

6. The manufacturing device of a lens assembly as claimed in claim 5, wherein the manufacturing device of a lens assembly further comprises a heating element, the heating element is located inside the pressing mold, the heating element is configured to heat the pressing mold, and keep difference value between the temperature of the pressing mold and the temperature of the softened first optical portion within a preset range, and reduce the temperature difference between the pressing mold and the softened first optical portion.

7. The manufacturing device of a lens assembly as claimed in claim 5, wherein the manufacturing device of a lens assembly further comprises an insulating portion, the insulating portion is placed between the first optical portion and the heating assembly.

8. The manufacturing device of a lens assembly as claimed in claim 7, wherein a projection of the insulating portion onto the first optical portion lies inside an outer face of the first optical portion.

9. The manufacturing device of a lens assembly as claimed in claim 7, wherein the insulating portion comprises an insulating cap and an insulating board, the insulating cap surrounds an outer side of the first optical portion, and the insulating cap is between the first optical portion and the first connecting portion, and an inner side of the first optical portion defines a first heating area, an outer side of the first optical portion 11 defines a second heating area.

10. The manufacturing device of a lens assembly as claimed in claim 9, wherein a cross section of the insulating board is bigger than a cross section of the first optical portion.

11. The manufacturing device of a lens assembly as claimed in claim 5, wherein a shape of the pressing groove is same with a standard surface of the first lens.

12. The manufacturing device of a lens assembly as claimed in claim 5, wherein the heating assembly is set as a non-contact heating component.

13. The manufacturing device of a lens assembly as claimed in claim 6, wherein the heating element comprises a heating tube, the heating tube is embedded in the pressing mold.

14. The manufacturing device of a lens assembly as claimed in claim 5, wherein the manufacturing device of a lens assembly further comprises a temperature detector, the temperature detector is configured to detect temperature of the first optical portion and temperature of the first connecting portion; the insulating board is placed between the heating assembly and the first optical portion.

15. The manufacturing device of a lens assembly as claimed in claim 5, wherein the heating assembly comprises a radiant heating face, the radiant heating face is parallel to the insulating board.

16. A lens assembly, jointing by the manufacturing method of a lens assembly as claimed in claim 1, comprising:
a first lens, the first lens comprises a first optical portion and a first connecting portion, the first optical portion comprises a first face; and
a second lens, the second lens includes a second optical portion and a second connecting portion, the second optical portion comprises a second face, the second face is bonded with the first face, the second connection portion is connected with the first connection portion.

17. The lens assembly as claimed in claim 16 wherein the second lens further comprises a plating layer, the plating layer is coated on the second optical portion, and a surface of the plating layer is formed as the second face.
